(19) United States
(12) Patent Application Publication
(10) Pub. No.: US 2023/0354919 A1
(43) Pub. Date: Nov. 9, 2023

(54) USER INTERFACE MODULE FOR AN AEROSOL PROVISION DEVICE

(71) Applicant: NICOVENTURES TRADING LIMITED, London (GB)

(72) Inventor: Zhihuang XIAO, London (GB)

(21) Appl. No.: 18/245,475

(22) PCT Filed: Sep. 15, 2021
(86) PCT No.: PCT/GB2021/052394

§ 371 Date: Mar. 15, 2023

(30) Foreign Application Priority Data
Sep. 15, 2020 (GB) 2014520.7

(51) Int. Cl. A24F 40/60; A24F 40/50; A24F 40/65; A24F 40/90; A24F 40/20

(52) U.S. Cl. CPC A24F 40/60; A24F 40/50; A24F 40/65; A24F 40/90; A24F 40/20

(57) ABSTRACT

A user-interface module for use with an aerosol provision device is described. The user-interface module includes a housing, a connector configured to interact with an aerosol provision device and a user interface. The user-interface module is configured to allow the user to interact with the user interface in order to control the functionality of an operatively connected aerosol provision device, thereby to provide the aerosol provision device with additional functionality, in use. There is also provided an aerosol provision device and a system.

### PRIORITY CLAIM

The present application is a National Phase entry of PCT Application No. PCT/GB2021/052394, filed Sep. 15, 2021, which claims priority from GB Application No. 2014520.7, filed Sep. 15, 2020, each of which hereby fully incorporated herein by reference.

### TECHNICAL FIELD

The present disclosure relates to a module for use with an aerosol provision device and a system comprising an aerosol provision device and one or more modules.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to a first aspect of the present disclosure, there is provided a user-interface module for use with an aerosol provision device, the user-interface module comprising: a housing; a connector configured to interact with an aerosol provision device; and a user interface; wherein, the user-interface module is configured to allow the user to interact with the user interface in order to control the functionality of an operatively connected aerosol provision device, thereby to provide the aerosol provision device with additional functionality, in use.

According to a second aspect of the present disclosure, there is provided an aerosol provision device comprising: a housing; an aerosol generator located within the housing; a power supply for powering the aerosol provision device; and a connector for releasably connecting the aerosol provision device to a user interface module; wherein, in use, when the aerosol provision device is operatively connected to the user interface module, functionality that is unavailable when the aerosol provision device is operatively disconnected from the user-interface module is activated in response to input received via the user interface module.

According to a third aspect of the present disclosure, there is provided a system comprising an aerosol provision device and a user-interface module according to the first aspect of the present disclosure, wherein the user-interface module is configured to be operatively connected to the aerosol provision device; the operative connection being: a direct connection to a connector of the aerosol provision device; or a connection to one or more other modules, wherein at least one of the one or more other modules is directly connected to a connector of the aerosol provision device, wherein, in use, when the aerosol provision device is operatively connected to the user interface module, functionality that is unavailable when the aerosol provision device is operatively disconnected from the user-interface module is activated in response to input received via the user interface module.

Further features and advantages of the disclosure will become apparent from the following description of various embodiments of the disclosure, given by way of example only, which is made with reference to the accompanying drawings.

### BRIEF DESCRIPTION OF THE DRAWINGS

FIG. 1 shows a schematic view of an example of a user-interface module.

FIG. 2 shows a schematic view of an example of an aerosol provision device.

FIG. 3 shows an example of a system including an operatively connected user-interface module and aerosol provision device.

FIG. 4 shows a schematic view of an example of an aerosol provision device.

FIG. 5 shows a schematic view of an example of a system including an operatively connected user-interface module and aerosol provision device.

FIG. 6 shows a schematic view of the system of FIG. 5, also showing a base of the user-interface module.

### DETAILED DESCRIPTION

As used herein, the term “aerosol-generating material” includes materials that provide volatilized components upon heating, typically in the form of an aerosol. Aerosol-generating material includes any tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

Apparatus is known that heats aerosol-generating material to volatilize at least one component of the aerosol-generating material, typically to form an aerosol which can be inhaled, without burning or combusting the aerosol-generating material. Such apparatus is sometimes described as an “aerosol provision device”, a “heat-not-burn device”, a “tobacco heating product device” or a “tobacco heating device” or similar. Similarly, there are also so-called e-cigarette devices, which typically vaporize an aerosol-generating material in the form of a liquid, which may or may not contain nicotine. The aerosol-generating material may be in the form of or be provided as part of a rod, cartridge or cassette or the like which can be inserted into the apparatus. An aerosol generator, such as a heater for heating and volatilizing the aerosol-generating material, may be provided as a “permanent” part of the apparatus, or could be combined with the aerosol-generating material in a replaceable or consumable component.

An aerosol provision device can receive an article comprising aerosol-generating material for heating. An “article” in this context is a component that includes or contains, in use, the aerosol-generating material, which is heated to volatilize the aerosol-generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article. Alternatively, aerosol-generating material can simply be located in a free or unconstrained manner in an aerosol-generation area, such as a heating chamber, of a device; loose leaf tobacco, for example, could be used in this way.

As used herein, the term “operative connection” is a connection through which power and/or data may be transmitted from a module to another module and/or to an aerosol provision device. A module that is “operatively connected” to an aerosol provision device may be connected directly to the aerosol provision device, or may be directly connected to one or more other modules if at least one of the one or more other modules is directly connected to the aerosol provision device. In such an arrangement, all of the connected modules are considered to be “operatively connected” to the aerosol provision device.

As used herein, when referring to a module, the term “in use” is when the module is operatively connected to an aerosol provision device. It is not required that the aerosol provision device is also in use by a user for the purpose of generating an aerosol for inhalation for it to be considered to be operatively connected; however, this may also be the case.

As used herein, the term “controller” is intended to mean any means by which the function of a device may be controlled. For example, a controller may comprise a simple switch configured to activate and deactivate the supply of electrical power from a power supply. Alternatively, a controller may comprise one or more microchips, which may be configured to control complex functionality in a device. A controller may be configured to allow a user direct control of the device or may be configured to control the function of a device automatically, such as in response to a user's puff, for example, or a combination thereof. Remote control of the device is also envisaged.

As used herein, the term “external device” refers to any device that is not an aerosol provision device or a module according to the present disclosure.

In order to improve user experience in the use of an aerosol provision device, there is a continual drive to improve device functionality. Aerosol provision devices typically include a very simple user interface, such as a single button interface. The user experience can be improved by including a more complex user interface, in order to give a user greater control over the functionality of the device. However, adding additional functionality to an aerosol provision device generally results in an increase in at least one of: the size, weight and cost of the device, any of which would be undesirable to the user.

The present disclosure addresses this problem by providing a user-interface module that is connectable to an aerosol provision device such that, in use, the module allows a user more control over the function of the device. Providing improved user interaction through a connectable module allows for the user experience to be improved while also allowing the aerosol provision device to remain small, light and inexpensive. In certain situations, therefore, a user can choose not to attach the user-interface module without losing the ability to use the aerosol provision device. For example, a user may wish to carry the aerosol provision device in a clothing pocket for a short time while they are moving around but when they return to a fixed position, such as sitting at a desk, they can re-attach the user-interface module to obtain greater device functionality.

A first aspect of the present disclosure defines a user-interface module for use with an aerosol provision device. The user-interface module comprises a housing and a connector configured to interact with an aerosol provision device. The connector is configured in any way that allows for an operative connection to be formed between the module and an aerosol provision device. The user-interface module further comprises a user interface and is configured to allow the user to interact with the user interface in order to control the functionality of an operatively connected aerosol provision device, thereby to provide the aerosol provision device with additional functionality, in use.

Forming an operative connection may involve a physical engagement between the connector of the module and a connector of either another module or an aerosol provision device. Such a physical connection may be achieved by the module comprising one or both of a male or female portion of a connector such as a USB Type C connector. Alternatively, the physical engagement may be achieved through a genderless connection. A physical connection has the advantage of improved reliability, and simple design. It additionally provides an opportunity for tactile feedback for users, in that a user can feel and/or see when a physical connection has been made between the module(s) and the aerosol provision device.

The connector may also be configured such that physical engagement is not necessary. An operative connection could be achieved, for example, through the use of a wireless data and/or power connection. The module may additionally be secured to another module and/or an aerosol provision device using, for example, magnetic attraction. Non-physical connections have the advantage that external connectors may not be necessary, reducing the risk of damage to the connectors during the lifetime of the devices and simplifying the design of the housing for both the module and the aerosol provision device. Whilst the additional securing of the module to another module and/or an aerosol provision device is not essential, it can assist in ensuring that the non-physical operative connection between the relevant components is reliable due to the retention of contact between the module and the relevant component.

A further alternative could be to use a physical engagement to secure the devices together, while the operative connection (i.e. the data and/or power connection) is achieved wirelessly. Such a physical engagement could be achieved, for example, by an interference fit between components, or through external engagement members. A physical engagement has the advantage that the user can more easily determine whether a connection has been made between the components, for example, through a tactile signal or simply by being able to visually perceive or feel that the connection has been made. A wireless operative connection avoids using power and/or data connections on the housing of any of the components to be operatively connected, thus simplifying the design and the manufacturing requirements of the housing.

According to a first aspect of the present disclosure, the user-interface module is configured such that, in use, the user-interface module is operatively connected to an aerosol provision device, either directly or via one or more further modules. In use, the user-interface module provides a user with additional means for controlling the aerosol provision device. As mentioned above, this has the advantage of allowing the aerosol provision device to be simple, small, lightweight and inexpensive, while allowing for the user to have control over the aerosol provision device functionality in addition to simply turning the device on and off.

Examples of specific functionality that may be included in an example of a user-interface module according to the first aspect of the present disclosure are discussed in more detail below. It should be understood that, unless explicitly stated otherwise, any of the following examples may be combined in a module according to the first aspect of the present disclosure.

The user-interface module may be configured to provide the user with information regarding the aerosol provision device. Such information could be, for example, the amount of power remaining in an internal power supply of the aerosol provision device, the estimated amount of puffs remaining in the power supply, the estimated amount of puffs remaining in a consumable article located in the device, detail on the type of puffs taken (for example, long and spaced apart or short and very frequent), information on the aerosol-generating material in the aerosol provision device, identification of the aerosol-generation device etc. It is understood that providing the user with more information regarding the aerosol provision device and any aerosol-generating material it contains would be considered to be beneficial by most users. The information could be provided on a display, such as an LCD screen, or audibly or in a tactile manner, for example using haptic feedback. These examples are discussed in more detail below.

The user-interface module may comprise one or more light emitting diodes (LEDs), which are configured, in use, to provide a user with information regarding the operatively connected aerosol provision device, and/or information regarding the user-interface module itself. LEDs have the advantage of requiring only minimal electrical power to operate. Furthermore, LEDs are available in a wide range of colors and can be constructed or arranged to be operated independently for different time periods, and thus even a small number of LEDs can be configured to provide a user with a variety of types of information by the use of different lighting up sequences.

The user-interface module may comprise a screen configured to display information to the user. Such a screen may be, for example, a liquid crystal display (LCD). A screen has the advantage of providing the user with more detailed or sophisticated information than would generally be possible through the user of other visual user interface components, such as LEDs. The information provided by a screen would also generally be expected to be clearer and easier for a user to understand than information indicated by other means.

In an example of a user-interface module comprising a screen, the screen may be a touchscreen configured to additionally receive user input. A touchscreen has the advantage of being able to both display information and receive user input, so that two-way interaction with the aerosol provision device is possible.

In another example of a user-interface module, the user interface may comprise one or more of: buttons, switches, dials and/or rolling buttons. Each of these means of interaction is simple in construction, easy for the user to use and inexpensive to manufacture. Furthermore, each of these user interface components can be configured to be both a means for configuring the aerosol provision device, and for indicating the present configuration to the user. For example, a switch could be configured to switch the aerosol provision device between a low power and a high power mode of operation (the low power and high power modes referring to the amount of electrical power being applied to an aerosol generator in the aerosol provision device); the position of the switch could also indicate to the user in which of the two modes the aerosol provision device was currently configured to operate. Similarly, a rolling switch or dial could be used to select from, and indicate to the user, multiple power modes in which the aerosol provision device could operate.

The user-interface module may comprise a user interface configured to provide the user with audible feedback. Such a user interface could comprise, for example, a loudspeaker, a buzzer or a clicker. Providing the user with audible feedback could be beneficial in brightly lit environments where LEDs or other illuminated feedback means could be difficult to accurately interpret. Furthermore, audible feedback would be beneficial to users with visual impairments, or users that, for any other reason, may find it difficult or distracting to interpret visual feedback or indications.

The user-interface module may comprise a user interface configured to provide the user with tactile feedback. Such a user interface could include, for example, a means for vibrating the device such as an asymmetrically weighted wheel attached to an electrical motor. Providing the user with tactile feedback would be beneficial in situations when the user is unable, or unwilling, to interpret visual or audible feedback. For example, a user in a brightly lit and noisy environment may find it difficult to accurately interpret illuminated lights on, or sounds emitted by, the device. Tactile feedback would also be beneficial in circumstances where visual or audible information may be inappropriate or distracting to the user or to others.

The user-interface module may comprise a user interface configured for receiving audible input. Such a user interface may be, for example, one or more microphones. This would allow for the module to be operated ‘hands-free’. In use, this could also allow for the operatively connected aerosol provision device to be controlled ‘hands-free’. This would be advantageous if the user is unable or unwilling to handle the module but wishes to input commands. For example, the user could have been using an aerosol provision device with an operatively connected user-interface module, and have subsequently put the device down and commenced another task, forgetting to switch the device off; in such circumstances the user could issue a verbal instruction to the module instructing the device to deactivate, thus avoiding the need to physically interact with the device.

The user-interface module may comprise a user interface configured for receiving tactile input. Such a user interface may be, for example, one or more accelerometers. This would allow for the user to interact with the device through motion. This could, for example, allow the module, and also an operatively connected aerosol provision device, to be automatically activated when picked up. This would be advantageous as it could allow the device to be switched on more quickly. For example, the user could configure the module such that when it is operatively connected to an aerosol provision device, the motion of the user picking up the module automatically activates the aerosol generator in the aerosol provision device. The inclusion of one or more accelerometers could allow for more complex motions to be accurately detected. This could allow for the user to configure the module to perform various actions in response to specific detected motions.

The user-interface module may contain an internal power supply. This has the advantage that, in use, the module would not require power to be supplied from another operatively connected device. In a situation where the user-interface module is operatively connected only to an aerosol provision device, this would allow the user-interface module to be used without depleting an internal power supply of the aerosol provision device. This is advantageous, because it would mean that use of the user-interface module would not reduce the electrical power available for operation of the aerosol provision device.

The internal power supply of the user-interface module may be a rechargeable battery or a capacitor. A rechargeable battery may be any suitable rechargeable battery; examples of suitable batteries include lithium-ion and nickel cadmium type batteries. Rechargeable power supplies such as rechargeable batteries and capacitors are advantageous as they can be easily recharged when depleted and can undergo a large number of charge-discharge cycles before needing to be replaced.

The internal power supply of a user-interface module may be configured to supply power to an operatively connected aerosol provision device or another connected module. This has the advantage that, in use, the user-interface module could recharge an internal power supply of the operatively connected aerosol provision device or module. A further advantage is that, in use, the operatively connected aerosol provision device could be provided with a very limited internal power supply, further reducing the size, weight and complexity of the aerosol provision device.

The user-interface module may contain means for wireless transmission of electrical power. This may comprise means for receiving electrical power from an external supply, such as from an external wireless charging pad. Alternatively, or in addition, the means for wireless power transmission may be configured to transmit electrical power to a further device, external to the housing of the user-interface module. The further device may be another module, an aerosol provision device or an external device configured to receive electrical power wirelessly. The user-interface module may comprise more than one means for wireless transmission of electrical power, such that the user-interface module may transfer electrical power to or from more than one device simultaneously. Transmitting electrical power wirelessly is advantageous because it may avoid the need for a physical connector to be located on the user-interface module housing. This would simplify the design and manufacturing requirements for the user-interface module housing and may also improve the safety and ease of use of the user-interface module. Furthermore, a module comprising means for transmitting and/or receiving electrical power wirelessly would allow for such functionality to be added to an operatively connected aerosol provision device, without the adding to the size, weight or cost of the aerosol provision device.

The user-interface module may contain means for physically connecting it to an external device. The physical connection may allow for electrical power to be supplied by the user-interface module to an external device or to the user-interface module from an external device. The external device may be, for example, a plug connected to a wall socket or a back-up power supply, such as a battery or another energy storage device, or a mobile phone, a tablet, a computer. This could allow for a user to interact with the user-interface module without it being operatively connected to an aerosol provision device, for example, to adjust pre-set user preferences.

In an example where the user-interface module is connected to an external source of electrical power, the supplied external power may be directed to charge at least one of: a power supply located within the user-interface module, i.e. an internal power supply; a power supply located within a further operatively connected module; and a power supply located within an operatively connected aerosol provision device, by means of a controller. The user-interface module may be configured such that the controller determines the amount of power being supplied to the module. The user-interface module may be further configured such that if the controller determines that the power supplied is insufficient to charge one or more of: the internal power supply of the user-interface module; the power supply of the operatively connected module; and the power supply located within the operatively connected aerosol provision device, the controller may preferentially direct the supplied power accordingly. The order in which the one or more power supplies should preferentially be charged may be pre-set or may be configurable by the user. It may be preferable for the power supply of an operatively connected aerosol provision device to be charged before any other power supplies, for example. The user-interface module may be further configured such that if the externally supplied power is insufficient to charge the internal power supply of the user-interface module, or any of the power supplies to which the user-interface module is operatively connected, the electrical power is not supplied to any of the power supplies. The user-interface module may also be configured to alert the user that the externally provided power supply is insufficient to charge one or more of the power supplies; the alert may be a visual, audible and/or tactile indication. The user-interface module may be additionally configured such that when an external power supply is connected, the user-interface module indicates to the user which, if any, of the operatively connected power supplies is being charged.

The user-interface module may comprise computer memory located inside the housing. This has the advantage that the module is able to store and retain information within the computer memory.

The internal computer memory of a user interaction module may be configured to store and retain user-specified configuration information. This could allow the user to use a different aerosol provision device, while retaining the user-specified configuration information in the user-interface module. For example, the user may have more than one aerosol provision device for use with different types of consumable articles; by retaining the user preferences in the internal computer memory, the user-interface module could allow the user to quickly and easily configure each device according to previously specified user configuration information. This may allow, for example, for the user to have a similar session experience across multiple different aerosol provision devices. For example, the user-interface module could provide an identical user-specified ‘end of session’ notification (audible, visual and/or tactile) when the session is reaching a conclusion, regardless of the type of aerosol provision device being used. Thus, by storing user-configured information, the user experience may be improved. In an example of such user-specified configuration information, a user could configure the module such that, in use, specific user-defined information is displayed by the user-interface module according to preference; the user could, for example, configure the user-interface module to provide visual, audible and/or tactile feedback during a smoking session when it is estimated that the consumable article is nearly depleted. As a further example, the user could specify how certain user interface components on the user-interface module may be used to interact with the aerosol provision device; the user could specify, for example, that a specific button or switch is to be used to activate or deactivate a higher power mode in the operatively connected aerosol provision device. Furthermore, the user-interface module could be configured such that a specific user-defined input sequence is required to unlock or activate the user-input module and/or the operatively connected device.

The user-interface module may comprise means for wireless communication with an external device. Examples of possible wireless communication protocols could be Bluetooth™, Wi-Fi™, cellular network communication etc. Wireless communication with an external device could allow for data transfer between the user-interface module and the external device. Such data could, for example, comprise user-specified configurations for the user-interface module and/or the operatively connected aerosol provision device. The data stored may also comprise usage data recorded by the aerosol provision device; such data could be used, for example, to automatically order more consumable articles when needed. The data transfer may also allow for the user-interface module to be configured according to the preferences of the user by means of the external device. An external device may be, for example, a mobile phone, a tablet, a computer etc.

In a further example in which the user-interface module comprises means for physically connecting it to an external device, the connection may be configured such that data transfer can take place. Such a connection may comprise, for example, a standard data connector such as USB Type C connector. The data connection may allow for data to be exchanged with the external device. Such data could comprise, for example, user-specified configurations for the user-interface module and/or the operatively connected aerosol provision device. The data transfer may also allow for the user-interface module to be configured according to the preferences of the user using the external device. An external device may be, for example, a mobile phone, a tablet, a computer, etc.

As previously noted, it will be appreciated that several of the examples discussed above could be combined with one another. For example, a module could include one or more means for user interaction, as discussed above, as well as power supply and/or data transfer functionality. Alternatively, or additionally, the module could comprise communications functionality. Whilst the possible module capabilities have been set out separately in some cases, their combination is not precluded within a single module.

According to a second aspect of the present disclosure, there is provided an aerosol provision device. The device comprises: a housing; an aerosol generator located within the housing; a connector, wherein the connector is configured to form a releasable operative connection to a user-interface module according to one or more examples of the first aspect of the disclosure, as described above. The aerosol provision device also comprises an internal power supply configured to supply power to the aerosol generator, which has the advantage of allowing the aerosol provision device to operate even when a module is not operatively connected to the device. In examples where the aerosol provision device comprises a limited internal power supply, supplementary electrical power may be supplied to the aerosol provision device, for example in order for its aerosol generator to function in a higher power mode. Such electrical power may be provided by an operatively connected module, or by an external power supply. Examples in which the aerosol provision device comprises a limited internal power supply may be advantageous as the size, weight and/or complexity of the aerosol provision device may be reduced.

According to a third aspect of the present disclosure, there is provided a system comprising an aerosol provision device and a user-interface module, wherein the user-interface module is operatively connected to the aerosol provision device; the operative connection being either: a direct connection to a connector of the aerosol provision device; or a connection to one or more other modules, wherein at least one of the one or more other modules is directly connected to a connector of the aerosol provision device, the operatively connected user-interface module providing the aerosol provision device with additional functionality, in use.

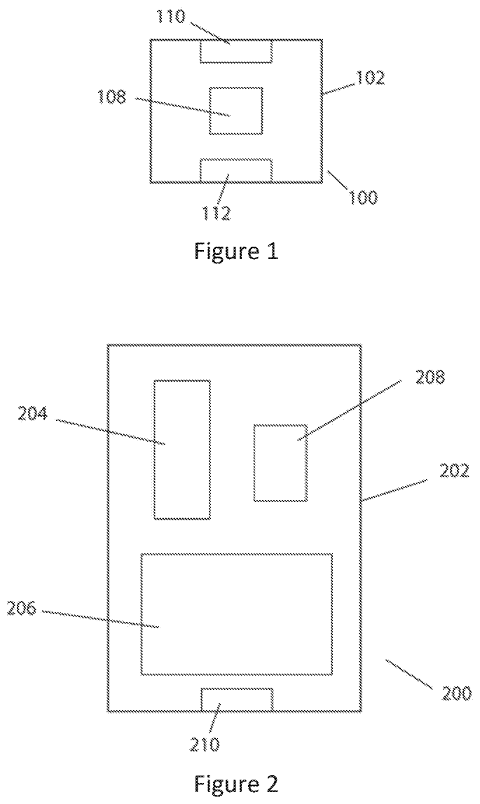

Referring to FIG. 1, a user-interface module 100 for use with an aerosol provision device is schematically illustrated. The user-interface module 100 comprises: a housing 100; a user interface 108 located on the housing 102 and a connector 110, the connector being configured to interact with either an aerosol provision device or another module. In some embodiments, the user-interface module 100 may comprise a second connector 112 (as shown in FIG. 1) and possibly further connectors (not shown). Each of the second and further connectors is configured to interact with either an aerosol provision device or a further module.

The housing 102 of the user-interface module 100 may be composed from any suitable material. A metallic material such as steel or aluminum may be used; stainless steel and aluminum are inexpensive, and easy to manufacture and offer good corrosion resistance. A housing comprising a metallic material may also offer improved dissipation of any heat generated within the device, increasing user comfort during use, and may be more aesthetically pleasing than alternative options. Electrically conductive materials may be used; a housing composed from an electrically conductive material may additionally function as an antenna to facilitate or improve wireless communication, in examples where the module comprises means for wireless communication, as described in more detail below. Alternatively, the housing may be made from plastic. Plastic is inexpensive, it can be easily formed into any desired shape and is not electrically conductive, which may help to improve the safety of the device. Examples of suitable plastic materials could be polycarbonate (PC), acrylonitrile butadiene styrene (ABS) or a combination of PC and ABS; PC and ABS are strong, tough, inexpensive and can be easily formed into any required shape. PC and ABS can also both be easily colored and decorated both within the structure of the plastic material and with surface paints; this allows for the housing 102 to be easily decorated. Furthermore, a plastic material may beneficially allow for a discrete antenna to be embedded with the plastic material of the housing or printed onto the outer and/or inner surface of the housing 102 in order to facilitate or improve wireless communication, in examples where the module comprises means for wireless communication, as described in more detail below. The housing 102 may be configured to be changeable, allowing for at least part of the housing 102 to be replaced by the user, for example to change its appearance.

The user-interface module 100 comprises a user interface 108. As discussed previously, the user interface 108 may comprise any suitable means by which the user may interact with the device. In use, the user interface 108 allow the user to interact with and configure the operation of an operatively connected aerosol provision device.

In one example, the user interface 108 comprises one or more buttons, switches, dials and rolling buttons.

In another example, the user interface 108 alternatively, or additionally, is configured to provide the user with information regarding the operatively connected aerosol provision device; such a user interface may include one or more means for providing visual (lights, LEDs etc.), audible (loudspeaker, clicker, buzzer, etc.) or tactile (vibrator, etc.) feedback.

In a further example, the user interface 108 additionally, or alternatively, comprises a screen. The screen may, for example, be an LCD screen. The screen can be a touchscreen configured to both display information to the user and receive user input.

The user-interface module 100 comprises a connector 110, the connector 110 being configured to connect to the connector of another module or an aerosol provision device. When connected to the connector of another device, the connector 110 of the user-interface module and the connector of the other device may be referred to as ‘a pair of connectors’.

In some examples, the first connector 110 and any further connectors are configured in such a way that an operative connection is formed with another module or with an aerosol provision device without physical engagement of the pair of connectors. If the housing 102 does not have any openings, it can be made water resistant in that the housing material is resistant to water and the lack of openings in the housing prevents water ingress into the internal components of the user-interface module. A means for securing the user-interface module 100 to at least one second device (a second device being another module or an aerosol provision device) without physical engagement of the pair of connectors can additionally be provided. In one example, the user-interface module 100 comprises at least one magnet (or a portion of magnetic material) arranged such that when the second device also comprises at least one magnet, the at least one magnet of the user-interface module and the at least one magnet of the second device secure the devices relative to one another by magnetic attraction. In this example, the one or more magnets are positioned such that the magnetic attraction between the magnet(s) of the module 100 and the magnet(s) of the second device cause the user-interface module 100 and the second device to be aligned in a manner that allows for the pair of connectors to be operatively connected. This type of alignment is particularly useful where the operative connection between the pair of connectors is a wireless one and there is, therefore, no additional physical engagement of the components.

In another example, the housing 102 of the user-interface module 100 is configured such that when the user-interface module 100 is connected to a second device, the housing 102 secures the user-interface module 100 to the second device by an interference fit. Such an arrangement could be achieved, for example, by configuring the housing 102 of the user-interface module 100 such that the housing 102 is configured to at least partially surround or enclose the second device, or vice versa. Other types of physical engagements between the user-interface module 100 and the second device are also possible, for example a screw or bayonet type connection, whereby a portion of the module housing 102 comprises a screw or bayonet type fitting to be inserted into a corresponding connector and twisted in order to form a secure engagement (or vice versa). The housing 102 could also comprise one or more movable engagement members, such as a latch or a spring-loaded button, or means to engage with such a moveable member of a second device, in order to improve the security of engagement with a second device. Physical engagement of this kind has the benefit that a user will have a tactile indication as to the security of the engagement.

In some examples, the pair of connectors is configured to be physically engaged in order to be operatively connected. In these examples, the housing 102 of the user-interface module 100 comprises one or more openings to facilitate connection with other devices. In one example, the first connector 110 and the second connector 112 are each arranged adjacent to an opening in the housing 102, such that each of the connectors can physically engage with a connector of another device when it is placed inside, or at least adjacent to, the respective opening in the housing 102.

In examples where the pair of connectors are physically engaged to make an operative connection, at least one of the connectors may comprise a ‘male’ portion, configured to be inserted into the ‘female’ portion of the corresponding connector. It is also possible that each connector comprises both a male and a female portion, such that any connector may be connected to any other connector. However, it is preferable that the connectors comprise only male or female portions, such that, in use, the number of male connector portions not connected to a female connector (i.e. non-connected male connectors) is minimized. The male portion of a connector must, by definition, extend outwards. Therefore, when the user-interface module is in use, a non-connected male connector is more likely to be accidentally damaged than a non-connected female connector. Furthermore, when a module is in use, a non-connected male connector could possibly cause damage to external objects, or discomfort to the user.

In one example, the first connector 110 of the user-interface module 100 is the only male connector of the module 100. The user-interface module 100 may comprise one or more additional female connectors, into which the male portion of a connector of another module or an aerosol provision device may be inserted. The user-interface module may be prevented from operating unless the first connector 110 is connected to another device (either another module or an aerosol provision device). Therefore, if the first connector 110 of the user-interface module 100 is connected to another device, it may be understood that, in use, a system comprising one or more such modules 100, operatively connected to an aerosol provision device, will have no modules comprising a non-connected male connector.

In one example, the user-interface module 100 comprises only a first connector 110, and no further connectors. A module according to this example may be connected to only one of: another module; or an aerosol provision device. A user-interface module 100 comprising only a first connector 110 offers a simplified design and easy manufacturing of the user-interface module. In such a module, it may be advantageous for the first connector 110 to be a male type connector.

The user-interface module 100 may comprise means for connecting to an external device (other than an aerosol provision device or another module), herein referred to as an ‘external connector’ (not shown in the figures). An external connector configured to form a physical connection with an external device may be a commercially available connector such as a USB Type-C, or a proprietary connector. An external connector may alternatively be a wireless external connector, configured to connect wirelessly to an external device. A wireless external connector may use, for example, Bluetooth™, Wi-Fi™, NFC or a cellular network connection. The external connector may allow for the module 100 to receive electrical power from an external device. The external connector may additionally or alternatively allow for the exchange of data between the module 100 and the external device. Such data may, for example, comprise user specified configurations for the user-interface module and/or the operatively connected aerosol provision device.

Referring to FIG. 2, an aerosol provision device 200 is schematically illustrated. The aerosol provision device 200 comprises: a housing 202 (which may also be referred to as the ‘outer cover’); and an aerosol generator in the form of a heater 204 located within the housing 202; and a connector 210 configured to interact with a module. The aerosol provision device further comprises a power supply 206 located within the housing 202 and simple user interface 208. The user interface 208 may comprise, for example, a single button. The aerosol provision device 200 is configured to function independently when not connected to any additional modules. The aerosol provision device 200 may comprise a puff sensor (not shown in the figures), configured to detect when a user is drawing on the aerosol provision device 200. The aerosol provision device 200 may comprise internal computer memory (not shown), configured to retain user defined preferences after the user-interface module has been disconnected.

As previously discussed, a user-interface module 100 allows a user to interact with an operatively connected aerosol provision device 200 in a sophisticated manner, without the need for the aerosol provision device 200 to comprise a complex user interface. Some example situations in which a user may wish to interact with the aerosol provision device 200 in an extended way (in contrast with simple activation/deactivation operations) are outlined below, along with possible configurations of a user-interface module 100 that could assist with these situations. It should be understood that these examples are merely intended to illustrate ways in which the user-interface module 100 could be configured in order to solve the technical problem of interacting with a simple, inexpensive aerosol provision device 200; these examples should not be considered to be an exhaustive list of possible enhanced functionalities which can be provided by the user-interface module 100.

In one application of a user-interface module 100, a user is able to interact with an operatively connected aerosol provision device 200, in order to configure the aerosol provision device according to the preferences of the user. For example. a user may wish to adjust the amount of electrical power provided to the aerosol generator 204 during a smoking session. The desire to modify the amount of electrical power provided to the aerosol generator may be based on a preferred sensory experience. Alternatively, or additionally, the user may wish to adjust the amount of electrical power provided to the aerosol generator in order to facilitate the use of different types of consumable articles in the aerosol provision device; it is generally understood that different consumable articles are likely to require a different ‘heating profile’ to be used by the aerosol generator, in use. A predetermined heating profile, which is essentially a time-temperature program, can be followed by the aerosol provision device to control the amount of electrical power provided to the aerosol generator, in order that the aerosol generator operates at a particular temperature at a pre-ordained time during a smoking session. A user-interface module may allow for a user to choose between two or more predetermined heating profiles (such as a low-power and a high-power heating profile etc.). A more complex user-interface module could allow the user to have more sophisticated control over heating profiles.

In order to allow a user to configure the aerosol provision device in this way, an operatively connected user-interface module could comprise, for example, a user interface comprising a single button and a means for indicating to the user the currently operating heating profile of the aerosol generator, such as one or more LEDs. A single LED could be configured to indicate the chosen heating profile, for example by showing different brightness, color, and/or by flashing in a certain pattern. The user could then press the button to change to a different pre-set heating profile. Alternatively, two or more buttons could be provided in order to allow for a specific heating profile to be selected more easily. The single LED could instead be replaced with several LEDs, with the number of LEDs illuminated indicating the chosen power level. The chosen heating profile could instead, or additionally, be indicated to the user audibly (by means of a loudspeaker, clicker, buzzer, etc.) or via tactile feedback such as a vibrator. Alternatively, the heating profile could be chosen by the user using a user interface component which simultaneously indicates the currently selected heating profile, such as a dial or rolling button with pre-defined/pre-set values indicated on the dial/rolling button. More detailed information regarding the chosen heating profile, and the options available, could be provided by including an LCD display configured to display digital letters/numbers. Alternatively, a more sophisticated display could be provided, which could allow for more information to be provided to the user. Such a display could also be a touch screen display, which would significantly increase the ease of user interaction. A more complex user interface, such as a more sophisticated display capable of displaying features such as menu options, could allow for the user to have more sophisticated control over the heating profiles applied to the aerosol generator (when the aerosol generator is in use). For example, a complex display (which could also be a touch screen) could allow the user to modify the details of existing heating profiles, or to create entirely new heating profiles according to the user's preference.

As described above, a user-interface module may be configured to allow the user to adjust the amount of electrical power provided to an aerosol generator, in use, in an aerosol provision device. This could facilitate many options for the user to use the user-interface module to provide an improved user experience when using the aerosol provision device. Examples outlining some of the options which could be configured through the use of a user-interface module are described below; it should be understood that these examples are merely some of the possible options envisaged and should not be considered as an exhaustive list of possibilities. Furthermore, any of the examples outlined below could be used in isolation or could be combined in any way in order to provide an improved user experience, through the use of a single user-interface module.

A user could configure the aerosol provision device (by using the user-interface module) to automatically switch to a higher power mode (i.e. supply a greater amount of power to the aerosol generator) when external electrical power is provided to the aerosol provision device. Such an external electrical power could be provided from a power supply contained in an operatively connected module (including the user-interface module itself) or could be provided from an external device such as a plug inserted into a wall socket. The aerosol provision device could also be configured to switch to a lower power mode (i.e. supply a lower amount of power to the aerosol generator) when external electrical power is no longer being supplied. The user could configure the user-interface module to determine the amount of externally supplied electrical power, and to only switch to a higher power mode if the externally supplied electrical power was determined to above a certain predetermined threshold. The user-interface module could alternatively be configured by the user to determine the amount of externally supplied electrical power, and to switch to the highest power mode for which the power supply was determined to be sufficient; the possible power modes could be pre-set or could be configured by the user using the user-interface module.

In an example where the user-interface module is configured to determine the amount of electrical power supplied to the aerosol provision device, and where the aerosol provision device contains a rechargeable internal power supply, a user may use the user-interface module to ensure the internal power supply is preferentially recharged before power is supplied in any other way to the aerosol provision device or any other components. Furthermore, the user may configure the user-interface module to automatically switch to a higher power mode only if the externally supplied electrical power is sufficient to recharge the internal power supply of the aerosol provision device and to operate the aerosol provision device in a higher power mode. The user-interface module could be configured to determine the amount of externally supplied electrical power, and to switch to the highest power mode for which the power supply is determined to be sufficient, while preferentially recharging the internal power supply of the aerosol provision device; the possible power modes could be pre-set or could be configured by the user using the user-interface module. The user-interface module may be configured by the user such that when the internal power supply of the aerosol provision device is recharged, or once the internal power supply is charged to a predetermined amount (an amount which may be selectable by the user), the internal power supply of the aerosol provision device is no longer preferentially charged.

A user could use the user-interface module to configure the aerosol provision device to automatically activate the aerosol generator when the puff detector detects the user is drawing on the device. The user could configure the aerosol generator to operate for a predetermined amount of time after a puff has been taken by the user, or to switch off as soon as the puff is complete. The user could configure, via the user-interface module, the aerosol generator to operate in a low power mode between puffs instead of deactivating. The user could configure the aerosol generator to deactivate after a predetermined amount of time in which no puff has been taken. The user could configure the user-interface module to require input from another user interface component (such as a button on the user-interface module or the aerosol provision device) before any input from the puff sensor is considered.

In another example where a user may wish to configure the aerosol provision device, the user could use the user-interface module to configure the aerosol provision device such that an unlock code is required in order to activate the device. Such an unlock code would allow for the user to prevent unauthorized use of the device. The unlock code may comprise physical, audible and/or tactile interactions with the user-interface module or the aerosol provision device. Once the user has configured the aerosol provision device to be ‘locked’ (i.e. to require an unlock code to be entered into the user-interface module), the aerosol provision device will not function until the user defined unlock code has been entered into the operatively connected user-interface module or aerosol provision device. In use, the user may configure the aerosol provision device to be locked or unlocked after the user-interface module is disconnected. For example, if the user wishes to use the aerosol provision device immediately after disconnecting the user-interface module, the user will configure the aerosol provision device to remain unlocked after the module has been disconnected. Alternatively, if the user does not wish to use the aerosol provision device immediately after disconnecting the user-interface module, the user may configure the aerosol provision device to be locked after the user-interface module is disconnected. If the user configures the aerosol provision device to be locked, any further use of the aerosol provision device after the module has been disconnected will be prevented, until the user-interface module is operatively connected and the previously configured unlock code is entered.

In addition to allowing for a user to configure properties of an aerosol provision device, the user-interface module could allow for the user to review information stored in an internal computer memory of an aerosol provision device, if one is provided. The user-interface module may also allow the user to review information stored in the internal computer memory of the user-interface module, this data having previously been copied from an internal computer memory of an aerosol provision device or stored locally on the user-interface module or obtained from an external device or cloud data source.

For example. a user may wish to review information regarding usage of an aerosol provision device. Simple information, such as the remaining power in the internal power supply contained within an operatively connected aerosol provision device could be conveyed to the user through a user interface component such as one or more LEDs. Such information could additionally, or alternatively, be provided through simple audible feedback (such as a clicker or buzzer) or through tactical feedback such as a vibrator. The remaining power in the internal power supply of the aerosol provision device could also be reported to the user in terms of the estimated number of smoking sessions remaining or puffs remaining in a particular smoking session, as determined by the user-interface module from previous user data or look-up tables.

In order to provide a user with more detailed or sophisticated information, a more complex user interface may be required, such as a display. More complex information could be, for example, detailed analysis of previous smoking sessions. Such analysis could allow the user to alter their use of the aerosol provision device during a smoking session, in order to improve their user experience, for example by changing the duration and/or volume of a puff. Detailed information regarding previous usage of the aerosol provision device may also provide the user with information regarding healthcare and wellbeing.

In an example of a user-interface module comprising means for communication with an external device (such as a physical connection, or wireless means such as Bluetooth™, Wi-Fi™ and cellular data), the user-interface module may be able to provide the user with information via the external device. This could allow the user, for example, to review the information on a computer. The user could also configure such the user-interface module to use the connection to an external device to order additional consumable articles when required. The requirement for additional consumable articles may be manually determined by the user or may be automatically estimated by the user-interface module based on previous usage of the aerosol provision device or standard pre-determined data.

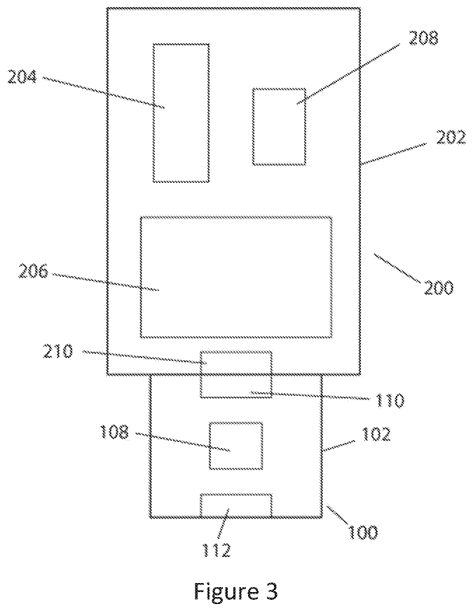

Referring to FIG. 3, a system comprising an aerosol provision device 200 and a user interaction module 100 is schematically illustrated. The connector 210 of the aerosol provision device 200 is directly connected to the first connector 110 the module. In such a system, the user-interface module 100 may comprise a second connector 112 to which an additional module may be connected. The aerosol provision device 200 may comprise a second and further connectors (not shown) configured to connect to additional modules.

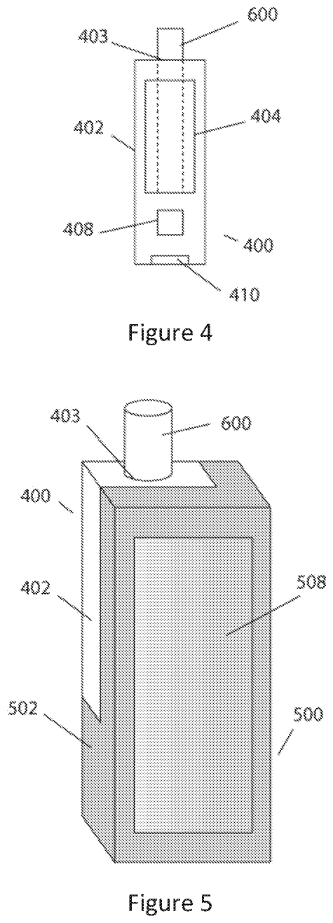

FIG. 4 illustrates a further example of an aerosol provision device 400, comprising: a housing 402; an opening in the housing 403, the opening 403 being configured to allow an article comprising aerosol-generating material 600 to be inserted into the aerosol provision device; a heater 404; a user interface 408, which is a simple on/off switch; and a connector 410. In this example, the user interface is a single button which may be configured to activate and/or deactivate the heater. As illustrated in FIG. 4, the article comprising aerosol-generating material 600 is inserted into the opening 403 and extends into the housing 402 into the heater 404. In this example, the aerosol provision device 400 does not comprise an internal power supply, and thus in use must be connected to either: a module configured to supply power to the aerosol provision device, or an external power supply.

FIG. 5 illustrates another example of a system comprising the aerosol provision device 400 and a user-interface module 500. The user-interface module 500 illustrated in FIG. 5 comprises a housing 502, and a user interface 508 located on the housing 502. In this illustrated example, the user interface 508 is a touchscreen. As the user interface 508 is a touchscreen, no other user interface components are provided on the module 500, although in some examples additional user interface components may be present.

In this example, the user-interface module 500 is configured such that when an operative connection is made between the first connector of the aerosol provision device 400 and the first connector of the module (not shown), the module 500 partially surrounds the aerosol provision device 400. Such an arrangement improves the strength and durability of the connection between the aerosol provision device 400 and the module 500 and provide a robust system overall. Such an arrangement also reduces the likelihood of the operative connection being accidentally broken during use, for example. Such an arrangement may also, in use, be more ergonomic than other arrangements, allowing for increased user comfort.

The aerosol provision device 400 and the module 500 illustrated in FIG. 5 are configured such that the aerosol provision device 400 may be slid into place in order to operatively connect to the module 500. In such an arrangement, the module 500 and aerosol provision device 400 may comprise means for assisting the user to properly align the two connectors; for example the housing 502 of the module 500 may comprise a guiding groove into which a protrusion located on the housing 402 of the module 400 may be slid in order to properly align the first connector 410 of the aerosol provision device and the first connector 510 of the module 500.

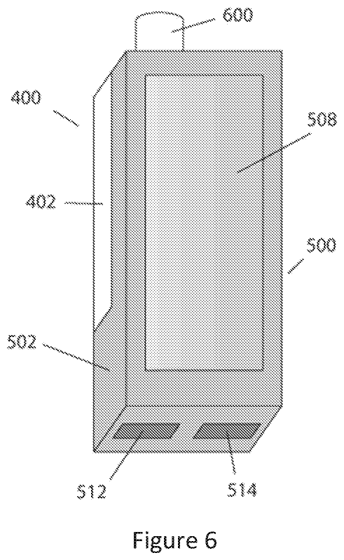

FIG. 6 shows an alternative view of the example illustrated in FIG. 5. In the example shown in FIG. 6, the user-interface module 500 is shown to comprise two connectors 512 and 514, in addition to the first connector (not shown) that is connected to the aerosol provision device 400. As discussed previously, the user-interface module may comprise a second or further connectors configured to connect to additional modules. Such additional modules may, in use, provide the operatively connected aerosol provision device 400 with additional functionality. For example, an additional module comprising an internal power supply could be connected to one of the additional connectors (512 or 514), thereby to provide the system with additional electrical power.

The above embodiments are to be understood as illustrative examples of the disclosure. Further embodiments of the disclosure are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A user-interface module for use with an aerosol provision device, the user-interface module comprising:
a housing;
a connector configured to interact with an aerosol provision device; and
a user interface;
wherein the user-interface module is configured to allow a user to interact with the user interface in order to control a functionality of an operatively connected aerosol provision device, thereby to provide the operatively connected aerosol provision device with additional functionality, in use.

2. The user-interface module according to claim 1, wherein, in use, the user-interface module is configured to provide the user with information regarding the operatively connected aerosol provision device.

3. The user-interface module according to claim 1, wherein the user interface comprises one or more LEDs.

4. The user-interface module according to claim 1, wherein the user interface comprises a screen configured to display information to the user.

5. The user-interface module according to claim 4, wherein the screen is a touchscreen, configured to additionally receive user input.

6. The user-interface module according to claim 1, wherein the user interface comprises one or more buttons, switches, dials and/or or rolling buttons.

7. The user-interface module according to claim 1, wherein the user interface is configured to provide the user with audible feedback.

8. The user-interface module according to claim 1, wherein the user interface is configured to provide the user with tactile feedback.

9. The user-interface module according to claim 1, wherein the user interface is configured to receive audible input.

10. The user-interface module according to claim 1, wherein the user interface is configured to receive tactile input.

11. The user-interface module according to claim 1, wherein the user-interface module contains an internal power supply.

12. The user-interface module according to claim 11, wherein the internal power supply is a rechargeable battery or a capacitor.

13. The user-interface module according to claim 9, wherein the user-interface module is configured to supply power to the operatively connected aerosol provision device.

14. The user-interface module according to claim 1, further comprising means for wireless transfer of electrical power.

15. The user-interface module according to claim 1, further comprising internal computer memory.

16. The user-interface module according to claim 15, wherein the user-interface module is configured to store user specified configuration information in the internal computer memory.

17. The user-interface module according to claim 1, wherein the module comprises means for communication with an external device.

18. The user-interface module according to claim 17, wherein the means for communication uses one or more of the following wireless communication protocols: Bluetooth™; Wi-Fi™; or cellular network communication.

19. An aerosol provision device comprising:
a housing;
an aerosol generator located within the housing;
a power supply for powering the aerosol provision device; and
a connector for releasably connecting the aerosol provision device to a user-interface module;
wherein, in use, when the aerosol provision device is operatively connected to the user-interface module, functionality that is unavailable when the aerosol provision device is operatively disconnected from the user-interface module is activated in response to input received via the user-interface module.

20. A system comprising an aerosol provision device and the user-interface module according to claim 1, wherein the user-interface module is configured to be operatively connected to the aerosol provision device the operative connection being:
a direct connection to a connector of the aerosol provision device; or
a connection to one or more other modules, wherein at least one of the one or more other modules is directly connected to a connector of the aerosol provision device,
wherein, in use, when the aerosol provision device is operatively connected to the user-interface module, functionality that is unavailable when the aerosol provision device is operatively disconnected from the user-interface module is activated in response to input received via the user interface module.
